(19) United States
(12) Patent Application Publication
(10) Pub. No.: US 2018/0257046 A1
(43) Pub. Date: Sep. 13, 2018

(54) DECANTING DEVICE

(71) Applicant: WENZHOU SORBO TECHNOLOGY Co., LTD, Wenzhou (CN)

(72) Inventors: Jianjun WU, Wenzhou (CN); Gang ZHOU, Wenzhou (CN); Jingdong HUANG, Wenzhou (CN); Ke WANG, Wenzhou (CN); Zhenyao DING, Wenzhou (CN)

(73) Assignee: WENZHOU SORBO TECHNOLOGY Co., LTD, Wenzhou (CN)

(21) Appl. No.: 15/975,797

(22) Filed: May 10, 2018

(30) Foreign Application Priority Data
Nov. 8, 2017 (CN) 201711090589.9

(51) Int. Cl. B01F 3/04

(52) U.S. Cl. CPC B01F 3/04794; B01F 2003/04319; B01F 2215/0072; B01F 3/04248

(57) ABSTRACT

A decanting device including a shell body, a switch, a pump body and a telescopic rod. The switch is electrically connected to the pump body. The pump body is arranged in the shell body and extends outward the shell body with a gas blowing port. The upper end of the telescopic rod is movably connected to the gas blowing port, and the lower end is provided with a plugging cover. The telescopic rod is hollowly arranged. A plurality of gas vent groups are arranged on the peripheral wall of the telescopic rod from bottom to top alternately, and each gas vent group includes gas outlet vents spaced along the circumferential direction. The gas outlet vent communicates with the gas blowing port of the pump body through the telescopic rod. The diameter of the gas outlet vent of the adjacent gas vent groups is reduced from bottom to top.

### CROSS REFERENCE TO RELATED APPLICATIONS

This application is based upon and claims priority to Chinese Patent Application CN 201711090589.9, field on Nov. 8, 2017, the entire content of which is incorporated herein by reference.

### TECHNICAL FIELD

The present invention relates to the technical field of daily necessities, particularly to a device capable of complete decantation.

### BACKGROUND

In wine culture, decanting is a very critical process. During the decanting process, the bottled wine is poured into the decanting vessel so that the wine in the bottle is in full contact with the external air to be oxidized, thereby accelerating the tannin softening, fully releasing aromas and catalyzing the process of decanting, to achieve the purpose of increasing the aroma and taste of red wine. In order to increase the decanting efficiency, the existing decanter blows in the external air through the pump body by the means of aeration, thereby mixing the air into wine, and the wine comes fully in contact with the air and the decanting of the wine is achieved. However, the decanting of the existing decanter is not enough, especially the oxidation of the liquid wine at the bottom is not sufficient, which affects the quality of the wine.

### SUMMARY

In view of the deficiencies of the prior art, the present invention provides a decanting device, the improved structure of it is simple and reasonable, may effectively decant wine at the bottom of the wine bottle, and has a high decanting efficiency.

The present invention provides a decanting device including a shell body, a switch, a pump body and a telescopic rod, the switch is electrically connected to the pump body, the pump body is arranged in the shell body and extends outward the shell body with a gas blowing port. The upper end of the telescopic rod is movably connected to the gas blowing port of the pump body, and a plugging cover is arranged on the lower end of the telescopic rod. The telescopic rod is hollowly arranged, and a plurality of gas vent groups are arranged on the peripheral wall of the telescopic rod from bottom to top at intervals. Each group of gas vents include gas outlet vents arranged along the circumferential direction at intervals, the gas outlet vents communicate with the gas blowing port of the pump body through the telescopic rod, and the diameter of the gas outlet vent of the adjacent gas vent groups is reduced from bottom to top.

The beneficial effect of this arrangement is as follows. With the above-mentioned solution, the telescopic rod is configured to such a form that the diameter of the gas outlet vent on the telescopic rod gradually increases from top to bottom. During the gas pumping process, the gas will preferentially enter the wine liquid from the gas outlet vent located above, while the lower gas vent has less gas output, so the wine liquid at the bottom cannot be in full contact with the air and release the aroma, making the wine liquid in the lower layer acidic and bitter. However, after the vent diameter of the gas outlet vent is gradually enlarged from top to bottom, the air escaping from the lower end of the telescopic rod is increased, the oxidation of the wine liquid in the lower layer and air is promoted, and the decanting efficiency is increased. Further, the gas outlet vents in each gas vent group may also be in inclined arrangement. For example, the gas outlet vents may be downwardly inclined. The gas outlet vent is configured in an inclined form, so that the escaping gas may form individual small cyclones in the wine liquid, promoting the contact between wine liquid and air, prolonging the existence time of the bubbles in the wine liquid, meanwhile performing the agitation. Further, since the bottom of the wine bottle is generally formed with a concave cavity in the circumferential direction, generally the wine liquid in the concave cavity is difficult to get in contact with the air and cannot be effectively decanted. The general decanter cannot reach the bottom directly, after the gas outlet vent is in inclined arrangement, the bubble escaping from the lower end of the telescopic rod may also reach the concave cavity, so that the oxidation of the wine in the concave cavity can be achieved.

The present invention is further provided with a connector arranged on an upper end of the telescopic rod, the telescopic rod is connected to a gas blowing port through the connector, and an upper end of the connector communicates with the gas blowing port, and a lower end of the connector is provided with a inserting groove. The telescopic rod is inserted in the inserting groove, the connector is circumferentially provided with a baffle ring for sealing the gas blowing port.

The beneficial effect of this arrangement is as follows. With the above mentioned solution, a connector is used to connect, which makes it more convenient to insert the decanting device into the bottle, contributing to the fixing of the decanting device at mouth of the wine bottle, and the baffle ring is further provided to ensure the sealing of the gas blowing port, preventing gas from escaping directly from the gas blowing port, and improving work efficiency.

The present invention further provides that the shell body is provided with a connecting port at a position corresponding to the gas blowing port. A fixing groove is formed on the connecting port, an upper end of the connector is connected to the connecting port, the upper end of the connector is provided with a block, the block is connected to the fixing groove by inserting into the fixing groove.

The beneficial effect of this arrangement is as follows. With the above mentioned solution, the insert-connection of block and the fixing groove is used for fixing, the fixing is tight, the disassembly is convenient, the connection between the connector and the shell body is effectively realized, and the detachable structure is convenient for the replacement of the telescopic rod. The telescopic rod with different lengths may be replaced to adapt to different wine bottles, meanwhile, it is also easy to replace a new one if the telescopic rod has problems.

The present invention further provides a snapping groove arranged on the fixing groove, and the snapping groove is snap-connected with the block for fixing the connector and the connecting port.

The beneficial effect of this arrangement is as follows. With the above mentioned solution, after the block is snapped into the fixing groove, the connector is rotated so that the block enters the snapping groove, so that the connector may be better connected to the connecting port, meanwhile the combination with the connecting port is tighter, and it does not get loose easily, and further guarantees the airtightness of the gas blowing port. Simultaneously, the structure is simple, easy to process, and the connection is good.

The present invention further provides a light source arranged on the connecting port along a circumferential direction for illuminating the wine. The light source is electrically connected to a switch, and the connector is made of a transparent material.

The beneficial effect of this configuration is as follows. With the above mentioned solution, the light source is provided, and the light source may be a breathing light, neon lights of various colors or a variety of light-emitting objects, which may irradiate the wine in the wine bottle through the transparent connector after being inserted into the bottle, making the wine generate different irradiation effects and look more beautiful, increasing the drinking interest of the drinker, improving the drinking mood. The light source is further arranged along the circumferential direction, so that the distribution of the irradiated light is more uniform and is convenient to observe from all angles.

### BRIEF DESCRIPTION OF THE DRAWINGS

FIG. 1 is a structural schematic view according to an embodiment of the present invention;

FIG. 2 is a partial enlarged view of part A in FIG. 1 according to an embodiment of the present invention;

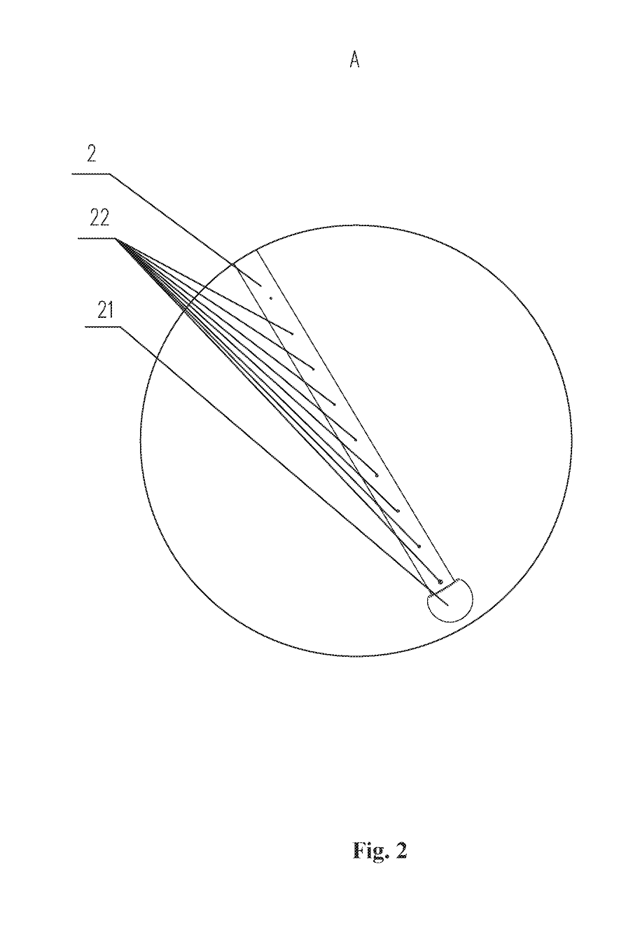

FIG. 3 is a structural schematic view of a shell body in an embodiment of the present invention;

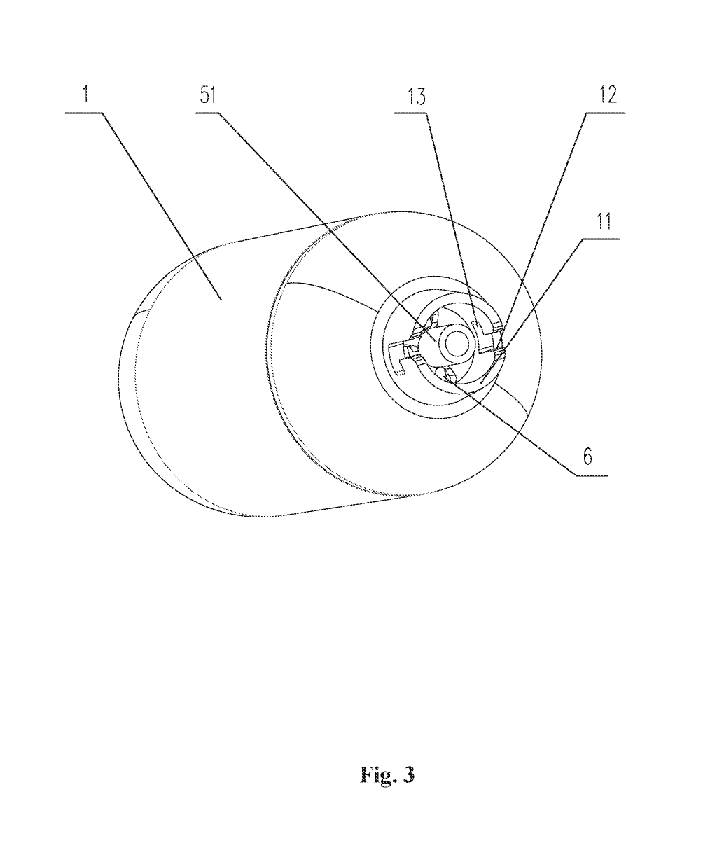

FIG. 4 is a structural schematic view of a telescopic rod and a connector according to an embodiment of the present invention.

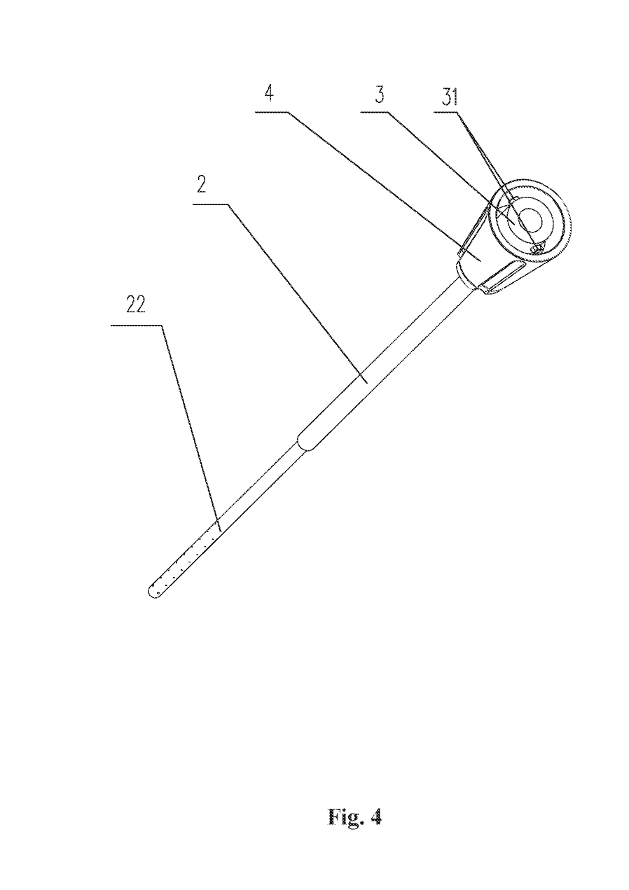

### DETAILED DESCRIPTION

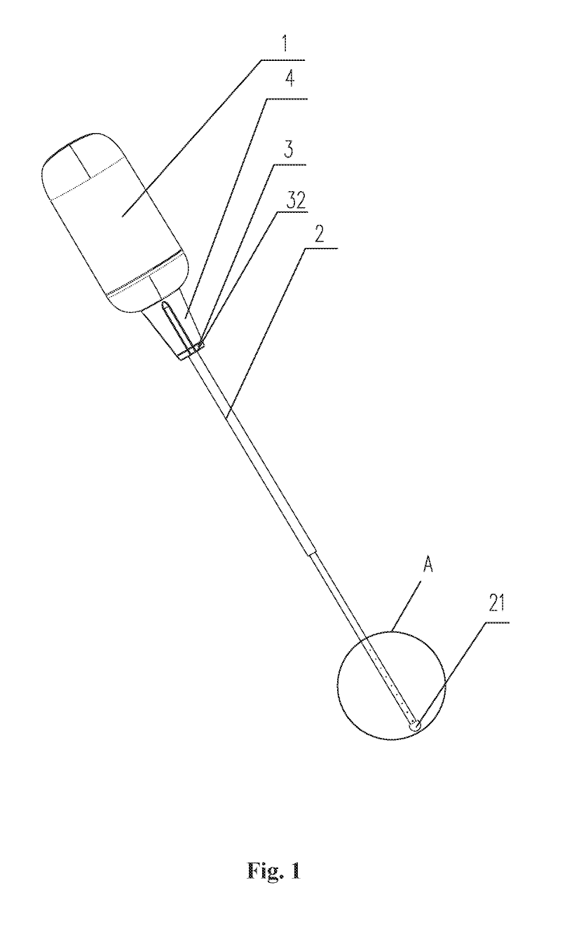

As shown in FIG. 1, the present invention discloses a decanting device including a shell body 1, a switch, a pump body and a telescopic rod 2. The switch is electrically connected to the pump body. The pump body is arranged in the shell body 1 and extends outwardly from the shell body 1 with a gas blowing port 51. The shell body 1 is provided with a connecting port 11 on the outside of the gas blowing port 51. The upper end of the telescopic rod 2 is connected to the connecting port 11 through a connector 3, and the communication between the gas blowing port 51 and the telescopic rod 2 is realized. The upper end of the connector 3 communicates with the connecting port 11 and the lower end is provided with an inserting groove 32, the telescopic rod 2 is inserted into the inserting groove 32. The connector 3 is circumferentially provided with a baffle ring 4 used to seal the gas blowing port 51. The pump body is movably connected to the gas blowing port 51. The connecting port 11 is formed with a fixing groove 12. The upper end of the connector 3 is connected to the connecting port 11. The upper end of the connector 3 is provided with a block 31. The block 31 is connected with the fixing groove 12 by inserting into the fixing groove. The fixing groove 12 is also provided with a snapping groove 13. The snapping groove 13 and the block 31 are snap-connected for fixing the connector 3 with the connecting port 11. A plugging cover 21 is covered on the lower end of the telescopic rod 2. The telescopic rod 2 is hollowly arranged. A plurality of gas vent groups are arranged on the peripheral wall of the telescopic 2 at intervals from bottom to top. Each gas vent group includes gas outlet vents 22 spaced along the circumferential direction. The gas outlet vent 22 communicates with the gas blowing port 51 of the pump body through the telescopic rod 2. The diameter of the gas outlet vent 22 of the adjacent gas vent groups is reduced from bottom to top. The connecting port 11 is further provided with a light source 6 for illuminating the wine liquid in the circumferential direction. The light source 6 is electrically connected to the switch. The connector 3 is made of a transparent material.

The above-mentioned embodiments are merely preferred embodiments of the present invention, and the right scope of the present invention is not limited thereto. Therefore, equivalent changes derived from the patent scope of the present invention, for example, equivalent products adopting similar processes and similar structures still belong to the protection scope of the present invention.

1. A decanting device, comprising:
a shell body, a switch, a pump body and
a telescopic rod,
the switch is electrically connected to the pump body, the pump body is arranged in the shell body and extends outwards the shell body with a gas blowing port, wherein
an upper end of the telescopic rod is movably connected to a gas blowing port of the pump body, and a plugging cover is covered on a lower end of the telescopic rod,
the telescopic rod is hollowly arranged, a plurality of gas vent groups are arranged on the peripheral wall of the telescopic rod from bottom to top at intervals, each of the plurality of the gas vent groups comprises a plurality of gas outlet vents spaced along a circumferential direction, the plurality of gas outlet vents communicate with the gas blowing port of the pump body through the telescopic rod, a diameter of the gas outlet vent of adjacent gas vent groups is reduced from bottom to top.

2. The decanting device according to claim 1, wherein
the upper end of the telescopic rod is provided with a connector, the telescopic rod is connected to the gas blowing port through the connector, an upper end of the connector communicates with the gas blowing port, an lower end of the connector is provided with an inserting groove, the telescopic rod is inserted into the inserting groove, the connector is circumferentially provided with a baffle ring for sealing the gas blowing port.

3. The decanting device according to claim 2, wherein
the shell body is provided with a connecting port at a position corresponding to the gas blowing port, a fixing groove is formed on the connecting port, and the upper end of the connector is connected to the connecting port, the upper end of the connector is provided with a block, the block is insert-connected to the fixing groove.

4. The decanting device according to claim 3, wherein
the fixing groove is further provided with a snapping groove, the snapping groove is snapped with the block to form a fixing between the connector and the connecting port.

5. The decanting device according to claim 3, wherein
the connecting port is provided with a light source for illuminating wine liquid along the circumferential direction, the light source is electrically connected to the switch, and the connector is made of a transparent material.
